(19) United States
(12) Patent Application Publication
(10) Pub. No.: US 2009/0211966 A1
(43) Pub. Date: Aug. 27, 2009

(54) Strainer filter

(76) Inventor: Kevin F. Hause, Milton, MA (US)

Correspondence Address: KEVIN F. HAUSE, 45 FROTHINGHAM STREET, MILTON, MA, 02186, US

(21) Appl. No.: 12/070,734

(22) Filed: Feb. 21, 2008

(51) Int. Cl. B01D 29/085

(52) U.S. Cl. 210/497.01

(57) ABSTRACT

When preparing food that requires rinsing, typically the food is transferred to a strainer, which holds the food while allowing water to passed over the food. This is typically performed in a sink with the water draining into the sink; however, during the rinsing process, food can become lodged in the strainer and cleaning the strainer can be cumbersome. This invention is a filter which can be placed into a standard kitchen strainer and serve as a barrier between the food being rinsed and the physical strainer. This would prevent food from touching the strainer thus easing the cleanup process of the strainer. The strainer filter could be disposed after use, if desired.

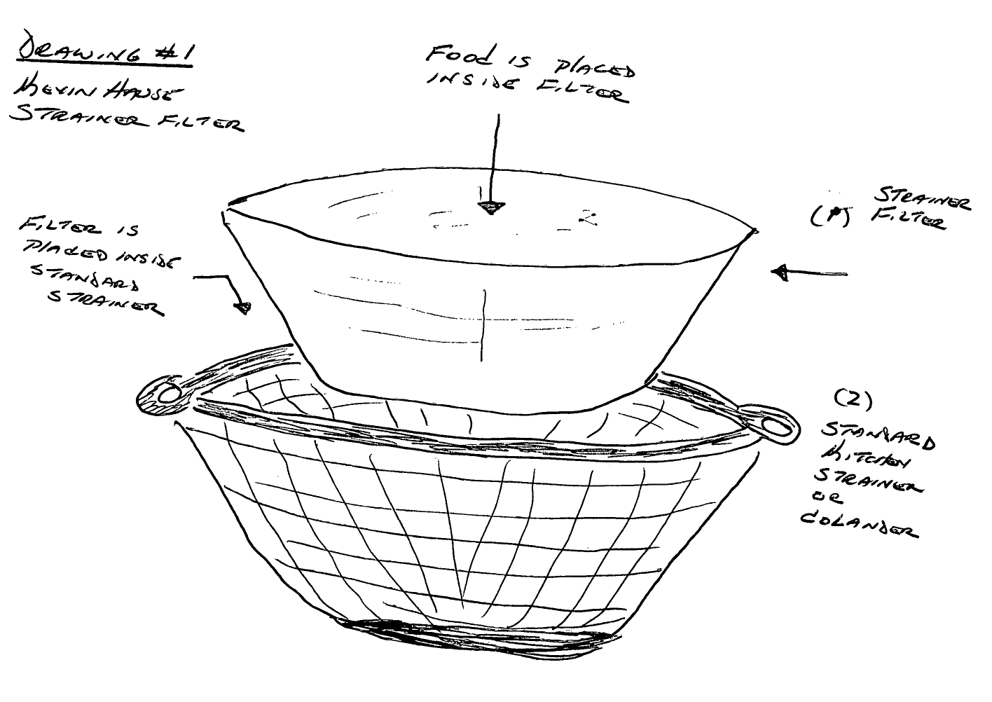

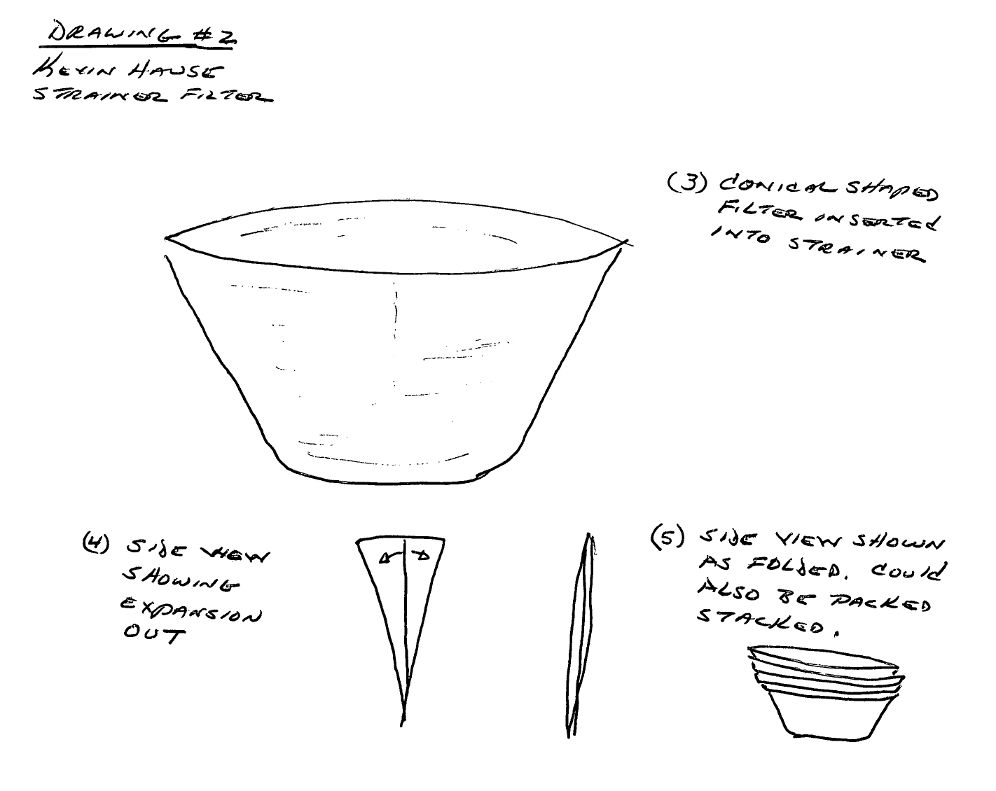

### BACKGROUND

The invention relates to easing the cleanup process associated with straining devices that are typically used for, but not limited, to pasta and could be applied to a variety of usages. When rinsing pasta under water, or any cooked/uncooked food that requires rinsing under water, a strainer is typically used to place the food into while running the food item under water. There is no barrier between the strainer and the food product and the strainer can often become clogged with residue from the rinsed food item. Cleaning a strainer after usage, especially if clogged with pasta, can be a time consuming effort and often the strainer is not completely cleaned. A significant amount of time, effort, and water is used in the strainer cleaning process and food particles can still lodge in the strainer and cause growth of bacteria. Washing strainers in a dishwasher is not always particle as food debris that circulates in the dishwasher can become lodged in the strainer as well. The Kitchen Strainer Filter eliminates the rigorous cleaning effort because it operates similar to a coffee filter in that it serves as a barrier between the product being rinsed with water and the device holding the food item. The benefit of this product is when used with a standard strainer is it eliminates the need to wash the strainer because the filter allows the passage of water, but blocks food residue from accumulating within a standard kitchen strainer. Many standard kitchen strainers are made from plastic or a stainless steel mesh which can be difficult to wash because of the multiple edges and crevasses that are inherent in the strainer's configuration. The strainer filter can be disposed of and the strainer can simply be rinsed thus eliminating the need of rigorous cleaning.

### SUMMARY OF THE INVENTION

The disposable strainer filter is designed to fit into a standard kitchen strainer whose size is generally between 10-12 inches at the strainer's topmost opening and narrows to about a 6-8 inch bottom, but not limited to these dimensions. The sides of most kitchen strainers are tapered toward a smaller flat bottom. The bottom generally serves as a foundation to support the strainer when it is placed on a flat surface. The standard kitchen strainer is generally used to strain pasta and other foods in the preparation of a meal. The Strainer Filter's design would allow for a universal fit into most standard kitchen strainers as described above and would allow food placement into the filter, which serves as a barrier between the food and the strainer, with the sides of the strainer supporting both the food and the Strainer Filter. The Strainer Filter can be embodied from a light weight material such as paper, but not limited to paper, and/or similar to materials found in standard coffee filters, or a combination of materials needed to give it sufficient structural support to maintain a conical shape, or such shape to be determined most efficient, to allow placement inside a typical household strainer with the approximate dimensions references above. After rinsing the food, the Strainer Filter would cling to the sides of the strainer allowing for the conveyance of food out of the strainer with the Strainer Filter remaining in the strainer. The Strainer Filter can be folded over inside the strainer, which would enclose any remaining food particles, and then removed from the strainer and squeezed to eliminate excess water, and then disposed of. No food residue would appear on the strainer itself, which could be rinsed with water. The Strainer Filter will be constructed of a material that makes this process the most efficient.

### BRIEF DESCRIPTION OF THE DRAWINGS

Drawing 1

(1) Disposable Strainer Filter

This sketch illustrates the Strainer Filter being inserted into a standard kitchen strainer. It appears rigid, but can be constructed from materials to make it more pliable to fit snuggly into the strainer. After placing the Strainer Filter into the strainer, the Strainer Filter would take the shape of the strainer leaving no gaps between the Strainer Filter and the strainer. The Strainer Filter's design may be such that it can be folded for ease of packaging and then unfolded into a more expanded position to ready the Strainer Filter for placement into the strainer.

(2) Standard Kitchen Strainer

This is a sketch of a standard kitchen strainer. It is to demonstrate the placement of the Strainer Filter into a strainer, but not limited to any one type of strainer as the Strainer Filter is intended for a universal fit into a standard kitchen strainer, or also referred to as a strainer.

Drawing 2

(3) Conical Shape

This sketch demonstrates the general shape of the Strainer Filter as it is designed to fit into a standard strainer. Its design is similar to a coffee filter in that is conical, or cylindrical, in shape, and intended to fit snuggly into a standard strainer, although the shape is subject to a final design to maximize function and utility. The aperture may be circular, rectangle, ovoid, or square. The bottom also could be circular, rectangle, ovoid, or square. The sided could be flat, creased, or take a ridged accordion shape, if needed.

(4) Side View with expansion

This sketch demonstrates how the Strainer Filter would be opened. When packaged, the Strainer Filter would lay flat and be folded with one side rested onto of the other (This is similar to pressing the palms of your open hands together). The Strainer Filter would be collapsible for easy storage. When needed for use, the Strainer Filter would be unfolded by pulling the folded sides apart to gain the shape needed to place into the strainer.

(5) Side View Shown as Folded

This is an illustration of a side view when the Strainer Filter is folded in half. The purpose of this drawing is to demonstrate the slimness of the strainer when it is folded in half. The Strainer Filter's body would be as slim as a standard coffee filter, but not limited to a particular thickness as design and function would determine the optimum construction including thickness of the Strainer Filter's walls. As an example to demonstrate the intended thickness of the Strainer Filter, but not limited to these dimensions, when folded in half, a stack of 25-50 Strainer Filters, would only be approximately ½-¾ inch high, depending on the final materials. The optimum design would make the Strainer Filter as thin as possible while maintaining structural integrity.

### DESCRIPTION OF THE PREFERRED EMBODIMENT

The Strainer Filter can be made from a low cost material similar to a coffee filter, but not limited to that material. The Strainer Filter must be constructed for ease of packaging, which may include the ability to fold the Strainer Filter, yet be able to unfold in a manner that allows for ease of unfolding and placement into the strainer. The materials would compliment this basic operation of the Strainer Filter and could be embodied from a combination of lower cost materials (paper, as one example, but not limited to paper), or another material or combination of materials, with a reinforcing method to provide added strength due to the size of the Strainer Filter, if needed. Generally, the materials would consist of similar materials used for standard coffee filters, as this would allow production of the Strainer Filter to leverage existing manufacturing technologies, although a modification of materials may be needed depending on testing. The color can be adapted to the appropriate color based on potential color contrast needed to make various food sources contrast appropriately against the background of the Strainer Filter.

What is claimed as being new and desired to be protected by Letters Patent of the U.S. is as follows:

1) A new strainer filter to be inserted into a standard kitchen strainer to be used as a barrier between the food item and the kitchen strainer to ease in the cleanup of the kitchen strainer.

2) The strainer filter is embodied from a light weight material, similar, but not limited to that of a coffee filter, that allows the strainer filter to take the shape of all kitchen strainers. The filter is produced at a low cost and designed for disposal after use. The material would compliment this use.

3) The size of the strainer filter would be constructed to fit inside a standard kitchen strainer that is approximately 8-12 inches across at the opening and tapers down approximately 5-8 inches to a bottom that is approximately 4-6 inches across in size. The strainer filter would be constructed in a manner to adapt to a kitchen strainer of these dimensions, but not limited to these dimensions. The idea is have a single strainer filter that can be used for all strainers so that a consumer can purchase a strainer filter and use that for all variations of standard kitchen strainers. The strainer filter's shape is designed to fit into any standard kitchen strainer and therefore be constructed in a manner designed to fit universally into all kitchen strainers.

4) The strainer filter can be constructed to be used without the aid of a kitchen strainer or other supporting device if needed, or can be used with a supporting apparatus other than a kitchen strainer and could be used outside the home if needed. Camping would be an example of outside the home use.

5) The strainer filter can be packaged for ease of home storage and distribution so that multiple strainer filters can be packaged into a single package, similar to coffer filters as an example, but not limited to coffer filter packaging. The packaging would allow for efficient home storage and allow for ease of removing a single strainer filter at a time.
